(19) United States
(12) Patent Application Publication
(10) Pub. No.: US 2012/0006841 A1
(43) Pub. Date: Jan. 12, 2012

(54) Flexible Packaging Material

(76) Inventors: John Picchietti, Roselle, IL (US); Jennie L. Dreikosen, Fond du Lac, WI (US)

(21) Appl. No.: 13/179,768

(22) Filed: Jul. 11, 2011

Related U.S. Application Data
(60) Provisional application No. 61/399,449, filed on Jul. 12, 2010.

(51) Int. Cl. B65D 43/16; B32B 7/02

(52) U.S. Cl. 220/810; 428/218; 428/216

(57) ABSTRACT

A flexible packaging material includes a first layer comprising low density polyethylene, a second layer comprising high density polyethylene, and a third layer comprising low density polyethylene. The material has a moisture vapor transmission rate of less than about 0.5 g/100 sq. in./day and an oxygen transmission rate of less than about 10 cc/100 sq. in./day.

### CROSS-REFERENCE TO RELATED APPLICATION

This application claims the benefit of U.S. Provisional Application No. 61/399,449, filed Jul. 12, 2010, which is incorporated by reference herein in its entirety.

### BACKGROUND

There is a continuing need for materials that can be used to form flexible packages for containing moist or wet contents. There is also a need for packages made from such materials. Depending on the particular application, such materials and packages formed therefrom may need to be puncture resistant and/or may need to be substantially impermeable to moisture or moisture vapor.

### SUMMARY

In one aspect, this disclosure is directed generally to a material for forming a package (i.e., a packaging material). The packaging material may be suitable for forming a package for containing one or more articles that have been moistened or wet by a liquid.

In another aspect, this disclosure is directed to a package for containing moist or wet articles. The package may include one or more opening features that allow the contents to be removed or dispensed from the package. Such opening features may be reclosable so that the package contents may be accessed repeatedly, while preventing any undesirable loss of moisture or liquid from the interior of the package.

The material and/or package of the present disclosure may be suitable for use with any wipe application, for example, baby wipes, antimicrobial wipes, window and/or surface cleaners, surface protectants, leather cleaners, and countless other applications.

Various other features, aspects, and embodiments will be apparent from the following description and accompanying figures.

### BRIEF DESCRIPTION OF THE DRAWINGS

The description refers to the accompanying drawings in which like reference characters refer to like parts throughout the several views, and in which:

FIG. 1A is a schematic cross-sectional view of an exemplary packaging material according to one aspect of the disclosure;

FIG. 1B is a schematic cross-sectional view of one layer of the packaging material of FIG. 1A;

FIG. 2A is a schematic perspective view of an exemplary package that may be formed from the packaging material of FIG. 1A;

FIG. 2B is a schematic cross sectional view of the package of FIG. 2A, taken along a line 2B-2B;

FIG. 2C is a schematic bottom plan view of the package of FIG. 2A;

FIG. 2D is a schematic front elevation view of the package of FIG. 2A, in a substantially flattened configuration;

FIG. 2E is a schematic bottom plan view of the package of FIG. 2D;

FIG. 3A is a schematic perspective view of another exemplary package that may be formed from the packaging material of FIG. 1A; and

FIG. 3B is a schematic front elevation view of the package of FIG. 3A, in a substantially flattened configuration.

### DESCRIPTION

Various aspects of the invention may be understood further by referring to the figures. For purposes of simplicity, like numerals may be used to describe like features. It will be understood that where a plurality of similar features are depicted, not all of such features necessarily are labeled on each figure. It also will be understood that the various components used to form the constructs may be interchanged. Thus, while only certain combinations are illustrated herein, numerous other combinations and configurations are contemplated hereby.

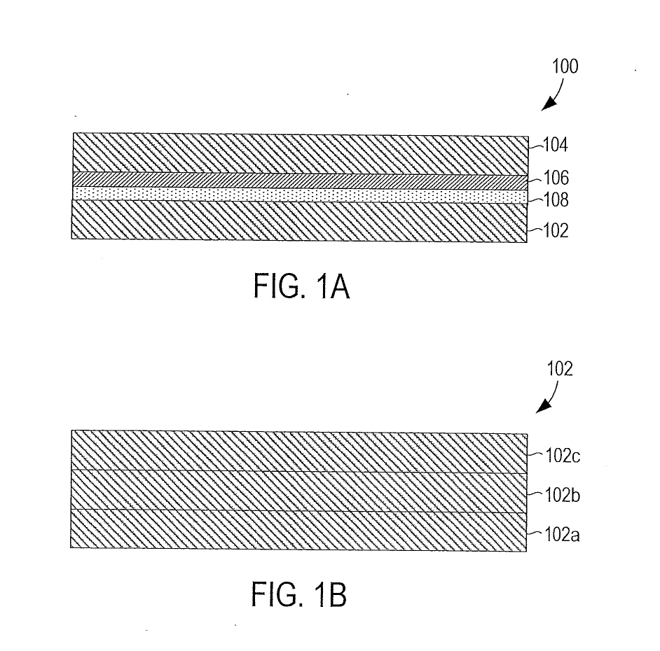

FIG. 1 depicts a schematic cross-sectional view of an exemplary packaging material 100. The packaging material 100 generally includes a plurality of layers joined to one another. For purposes of convenience, some layers may be described as “overlying” or being disposed “on” other layers. However, it will be appreciated that the packaging material 100 may be inverted, such that other layers “overlie” or are “on” one another. Accordingly, such terminology is provided merely for convenience of explanation and not limitation in any manner.

Further, while one specific structure 100 is illustrated schematically in FIG. 1, it will be appreciated that numerous other packaging materials are contemplated by the disclosure, and that each of such packaging materials may include various layers. Layers may be added or omitted as needed. It also will be appreciated that various materials may be used to form each layer of the packaging material, and that each layer may have various basis weights or coat weights and may be present in the packaging material in any suitable relative amount, depending on the particular application. Further, it will be appreciated that each layer may serve more than one purpose in a particular packaging material, and that any layer names are provided for convenience of explanation and not limitation in any manner.

In the illustrated embodiment, the packaging material 100 includes a first polymer film layer 102 and a second polymer film layer 104. The second polymer film 104 may be optionally printed with a continuous or discontinuous ink layer 106, such that the ink 106 is disposed on the second polymer film layer 104 (e.g., on an interior side of the second polymer film layer 104). The first polymer film layer may be joined to the ink layer and/or the second polymer film layer using an adhesive 108 or other suitable material.

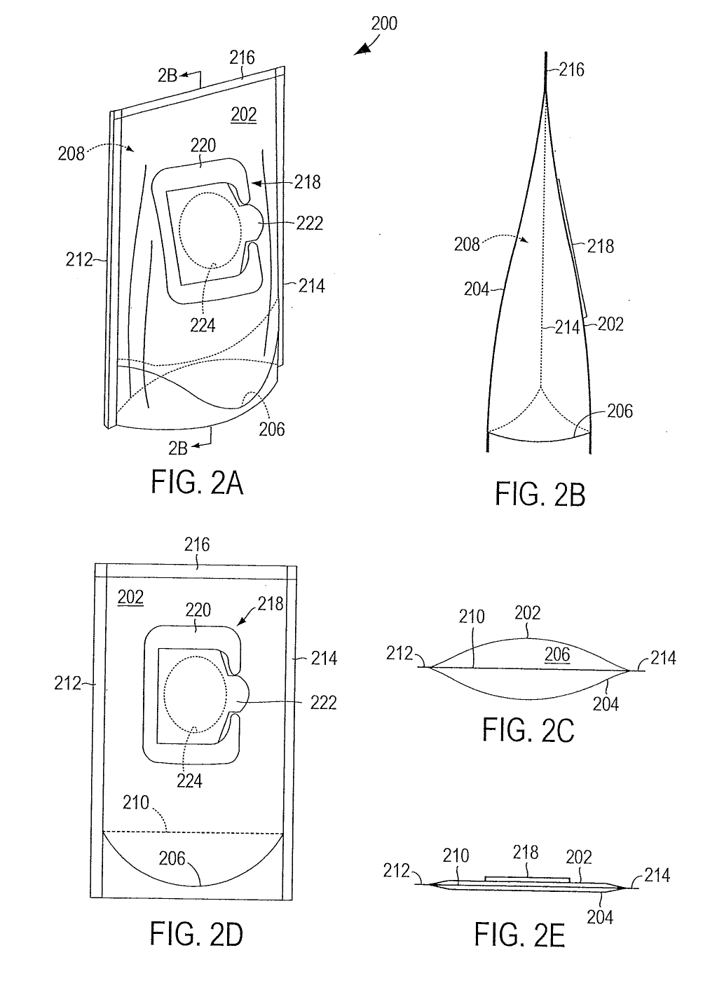

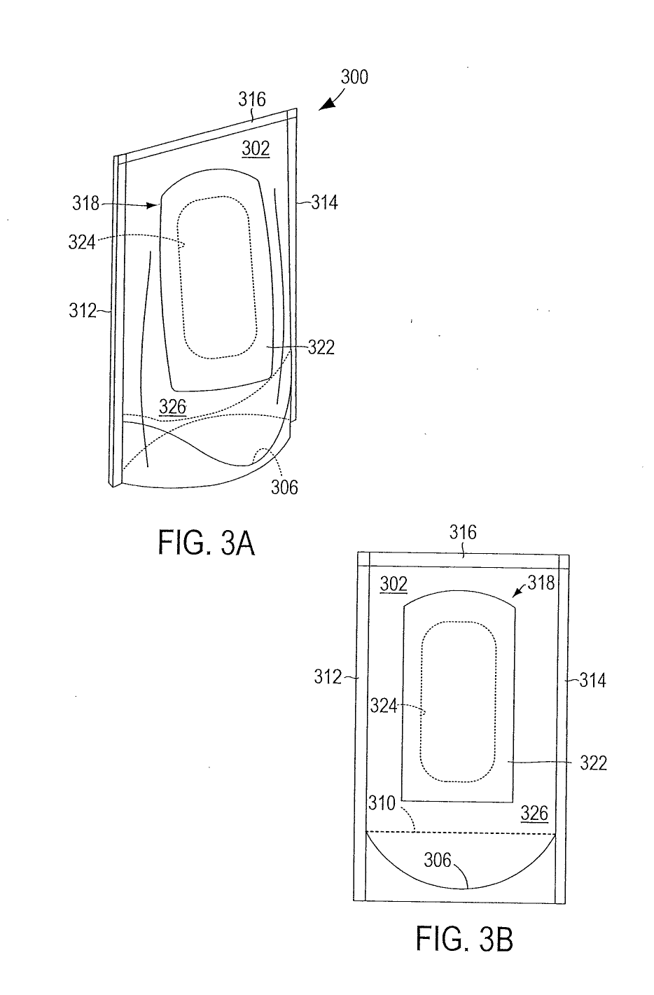

Each layer 102, 104, 106, 108 is in a substantially facing, contacting relationship with the respective adjacent layer(s) or material. When used to form a package (e.g., FIGS. 2A-3B), the first polymer film layer 102 (i.e., the outermost surface of the polymer film layer 102) may generally face inwardly towards the interior of the package and/or at least partially define the interior surface of the package, and polymer film layer 104 (i.e., the outermost surface of the polymer film layer 104) may generally face outwardly and/or define the exterior surface of the package.

Various materials may be used to form each layer of the packaging material 100. For example, the first polymer film 102 may comprise a multilayer structure including a plurality of adjoined layers in a facing, substantially contacting relationship with one another. In one example shown schematically in FIG. 1B, the first polymer film 102 may include a first layer 102a comprising a polyolefin, for example, low density polyethylene (LDPE), a second layer 102b comprising a polyolefin, for example high density polyethylene (HDPE), and a third layer 102c comprising a polyolefin, for example, LDPE. However, in other examples, other numbers of layers and other types of layers (e.g., different polymers) may be used.

The relative amounts of the various layers 102a, 102b, 102c may vary for each application. In one example, the first layer 102a may comprise from about 20 to about 40 wt % of the first polymer film, the second layer 102b may comprise from about 30 to about 50 wt % of the first polymer film, and the third layer 102c may comprise from about 20 to about 40 wt % of the first polymer film. In another example, the first layer may comprise from about 25 to about 35 wt % of the first polymer film, the second layer may comprise from about 35 to about 45 wt % of the first polymer film, and the third layer may comprise from about 25 to about 35 wt % of the first polymer film. In a more particular example, the first layer may comprise about 30 wt % of the first polymer film, the second layer may comprise about 40 wt % of the first polymer film, and the third layer may comprise about 30 wt % of the first polymer film. However, other suitable relative amounts of the layers may be used.

The first polymer film 102 may have a caliper or thickness of from about 2 to about 6 mil (mil=0.001 inches), for example, from about 3 to about 5 mil. In one particular example, the first polymer film may have a thickness of about 4.5 mil, for example, 4.6 mil. However, other suitable thicknesses may be used, depending on the needs of the particular application. For example, where additional barrier properties and/or strength are needed, thicker polymer films may be used.

The first polymer layer 102 may be formed in any suitable manner. For example, one or more of the layers 102a, 102b, 102c may be coextruded or, alternatively, may be formed and/or joined in a sequential manner. Numerous other processes are contemplated hereby.

The second polymer film layer 104 may comprise any suitable material. In one example, the second polymer film layer comprises a polyester, for example, polyethylene terephthalate. The second polymer film may have a caliper or thickness of from about 0.1 to about 1 mil, for example, from about 0.25 to about 0.75 mil. In one particular example, the second polymer film may have a thickness of from about 0.4 to about 0.6 mil, for example, 0.5 mil. However, other suitable materials and thicknesses thereof may be used, depending on the requirements for the particular packaging application. For example, where additional barrier properties and/or strength are needed, thicker polymer films may be used.

Any suitable ink 106 and adhesive 108 may be used. In one example, the adhesive may comprise Adcote™ 555/Adcote™ 536B laminating adhesive (Rohm & Haas). However, other possibilities are contemplated.

The basis weight of the packaging material 100 may vary for each application. For example, the basis weight of the packaging material may be from about 50 to 100 lb/ream (lb/3000 sq. feet), for example, from about 60 to 90 lb/ream, from about 65 to 85 lb/ream, from about 67 to about 82 lb/ream, for example, about 75 lb/ream. However, other basis weights may be used where needed.

The present inventors have discovered that the packaging material described herein may be suitable for a variety of packaging applications, including, for example, containing moistened or wet contents, such as wipes. The packaging material achieves the desired level of strength, puncture resistance, and tear resistance, and moisture and oxygen impermeability.

For example, the packaging material 100 may generally have a moisture vapor transmission rate (MWTR) of less than about 1 g/100 sq. in./day, for example, less than about 0.8 g/100 sq. in./day, less than about 0.7 g/100 sq. in./day, less than about 0.6 g/100 sq. in./day, less than about 0.5 g/100 sq. in./day, less than about 0.4 g/100 sq. in./day, less than about 0.3 g/100 sq. in./day, less than about 0.2 g/100 sq. in./day, or less than about 0.1 g/100 sq. in./day. In one particular example, the material may generally have a MVTR of about 0.1 g/100 sq. in./day. However, other WVTRs and ranges thereof may be suitable, depending on the particular application.

The material 100 may generally have an oxygen transmission rate (OTR) of less than about 25 cc/100 sq. in./day, for example, less than about 20 cc/100 sq. in./day, less than about 18 cc/100 sq. in./day, less than about 17 cc/100 sq. in./day, less than about 16 cc/100 sq. in./day, less than about 15 cc/100 sq. in./day, less than about 14 cc/100 sq. in./day, less than about 13 cc/100 sq. in./day, less than about 12 cc/100 sq. in./day, less than about 11 cc/100 sq. in./day, less than about 10 cc/100 sq. in./day, or less than about 9 cc/100 sq. in./day. In one particular example, the material may generally have an OTR of about 8.8 cc/100 sq. in./day. However, other OTRs and ranges thereof may be suitable, depending on the particular application.

The material 100 may be formed into a variety of different packages. By way of example, and not limitation, FIGS. 2A-2E schematically illustrate an exemplary package 200 that may be formed from the packaging material 100 of FIGS. 1A and 1B. The package 200 generally comprises a stand up pouch including a pair of opposed panels or walls 202, 204 (e.g., first or front panel 202 and second or back panel 204) and a base panel 206 (e.g., third or bottom panel 206) that define an interior space 208 for receiving and containing the package contents (not shown). The bottom panel 206 may be gusseted (i.e., provided with a fold line or crease 210), so that it can fold inwardly and the package can be configured in a generally flattened shape.

As shown schematically throughout the figures, the first panel 202 and the second panel 204 may be joined to one another along respective side marginal areas to form first and second side seals 212, 214. The closed package 200 may also include a top seal 216 (e.g., a third seal) along an upper marginal area of the first panel 202 and second panel 204.

If desired, the front panel 202 may include one or more features for accessing the contents of the package. For example, in the exemplary embodiment shown schematically in FIGS. 2A-2E, the package 200 includes a reclosable opening feature 218 in the form of a rigid label. The rigid label may generally comprise a frame 220 and a cover 222, one or both of which may be formed from a rigid or semi-rigid plastic. The frame 220 may be attached to the front panel 204. When the cover 222 is lifted, the user is able to access the package contents through an opening 224 (shown with dashed lines) in the front panel 204. In one embodiment, the cover 222 may be hingedly joined to the frame 220, so that the cover 222 may be opened and closed repeatedly to access the package contents through the opening 224. In other embodiments, the cover 222 may slide open, snap off and on, or may have any other configuration.

FIGS. 3A and 3B schematically depict an exemplary variation of the package 200 of FIGS. 2A-2E. The package 300 includes features that are similar to the package 200 shown in FIGS. 2A-2E, except for variations noted and variations that will be understood by those of skill in the art. For simplicity, the reference numerals of similar features are preceded in the figures with a “3” instead of a “2”.

In the embodiment shown in FIGS. 3A and 3B, the package 300 includes a reclosable opening feature 318 in the form of a flexible label or cover 322 that overlies the opening 324 and, optionally, a portion of the front panel 302. In such an embodiment, the flexible cover 322 may comprise a polymer film or coated paper that may be adhesively joined (or otherwise attached) to an exterior surface 326 of the package 300. The adhesive may be selected so that the label or cover 322 can be removed from and attached to the package 300 repeatedly.

It will be appreciated that the packages of this disclosure may be formed from numerous other packaging materials. It will likewise be appreciated that the packaging materials of this disclosure may be used to form countless other packages.

The present invention may be understood further in view of the following Example, which is not to be construed as limiting in any manner.

### EXAMPLE

A packaging material (e.g., packaging material 100) having the following structure was produced: 48 gauge polyethylene terephthalate (PET) film; ink; adhesive (e.g., Adcote 555/Adcote 536B laminating adhesive, Rohn & Haas); 4.0 mil coextruded LDPE/HDPE/LDPE (e.g., white high barrier). The packaging material had a basis weight of about 75 lb/ream, a caliper of about 4.6 mil, a MVTR of about 0.1 g/100 sq. in./day @100° F./90% RH, and an OTR of about 8.8 cc/100 sq. in./day @73° F./90% RH.

The packaging material was formed into packages similar to those shown in FIGS. 2A-3B. The packaging material was found to provide excellent strength and moisture retention for moist content (e.g., wipe) applications.

While the present invention is described herein in detail in relation to specific aspects and embodiments, it is to be understood that this detailed description is only illustrative and exemplary of the present invention and is made merely for purposes of providing a full and enabling disclosure of the present invention and to set forth the best mode of practicing the invention known to the inventors at the time the invention was made. The detailed description set forth herein is illustrative only and is not intended, nor is to be construed, to limit the present invention or otherwise to exclude any such other embodiments, adaptations, variations, modifications, and equivalent arrangements of the present invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other. Further, various elements discussed with reference to the various embodiments may be interchanged to create entirely new embodiments coming within the scope of the present invention.

What is claimed is:

1. A flexible packaging material, comprising:
a first layer comprising low density polyethylene,
a second layer comprising high density polyethylene, and
a third layer comprising low density polyethylene,
wherein the first layer, second layer, and third layer define a first polymer film, and wherein the material has a moisture vapor transmission rate of less than about 0.5 g/100 sq. in./day and an oxygen transmission rate of less than about 10 cc/100 sq. in./day.

2. The material of claim 1, wherein the second layer is disposed between the first layer and the third layer.

3. The material of claim 1, wherein
the first layer comprises from about 25 to about 35 wt % of the first polymer film,
the second layer comprises from about 35 to about 45 wt % of the first polymer film, and
the third layer comprises from about 25 to about 35 wt % of the first polymer film.

4. The material of claim 1, wherein the first layer, second layer, and third layer are coextruded layers of the first polymer film.

5. The material of claim 1, further comprising a second polymer film joined to the first polymer film.

6. The material of claim 5, wherein the second polymer film comprises polyethylene terephthalate.

7. The material of claim 5, further comprising ink disposed between the first polymer film and the second polymer film.

8. The material of claim 1, wherein the first polymer film has a thickness of from about 2 to about 6 mils.

9. The material of claim 1, wherein the first polymer film has a thickness of from about 3 to about 5 mil.

10. The material of claim 1, wherein the second polymer film has a thickness of from about 0.1 to about 1 mil.

11. The material of claim 1, wherein the second polymer film has a thickness of from about 0.25 to about 0.75 mil.

12. The material of claim 1, wherein the second polymer film has a thickness of from about 0.4 to about 0.6 mil.

13. The material of claim 1, wherein
the first polymer film has a thickness of about 4.6 mil, and
the second polymer film has a thickness of about 0.5 mil.

14. The material of claim 1, formed into a package.

15. The material of claim 14, formed into the package, wherein the first polymer film defines an interior side of the package.

16. The material of claim 14, formed into the package, wherein the package includes a reclosable opening feature.

17. The material of claim 14, formed into the package, wherein the package includes a reclosable opening feature comprising a cover hingedly joined to a frame.

18. The material of claim 14, formed into the package, wherein the package includes a reclosable opening feature comprising a flexible cover adhesively joined to an exterior surface of the package.

19. A flexible packaging material, comprising:
a first polymer film layer including
a first layer comprising low density polyethylene, the first layer comprising from about 25 to about 35 wt % of the first polymer film,
a second layer comprising high density polyethylene, the second layer comprising from about 35 to about 45 wt % of the first polymer film, and
a third layer comprising low density polyethylene, the third layer comprising from about 25 to about 35 wt % of the first polymer film,
wherein the first polymer film layer has a thickness of from about 2 to about 6 mils;
a second polymer film layer comprising polyethylene terephthalate, wherein the second polymer film layer has a thickness of from about 0.1 to about 1 mil; and
ink disposed between the first polymer film layer and the second polymer film layer.

20. The material of claim 19, wherein the first polymer film has a thickness of from about 3 to about 5 mil.

21. The material of claim 19, wherein the first polymer film has a thickness of about 4.6 mil.

22. The material of claim 19, wherein the second polymer film has a thickness of from about 0.25 to about 0.75 mil.

23. The material of claim 19, wherein the second polymer film has a thickness of from about 0.4 to about 0.6 mil.

24. The material of claim 19, wherein the second polymer film has a thickness of about 0.5 mil.

26. The material of claim 19, wherein the material has a moisture vapor transmission rate of about 0.1 g/100 sq. in./day.

27. The material of claim 19, wherein the material has a moisture vapor transmission rate of less than about 0.5 g/100 sq. in./day.

28. The material of claim 19, wherein the material has a moisture vapor transmission rate of about 0.1 g/100 sq. in./day.

29. The material of claim 19, wherein the material has an oxygen transmission rate of less than about 15 cc/100 sq. in./day.

30. The material of claim 19, wherein the material has an oxygen transmission rate of less than about 10 cc/100 sq. in./day.

31. The material of claim 19, wherein the material has an oxygen transmission rate of about 8.8 cc/100 sq. in./day.

32. The material of claim 19, formed into a package.

33. The material of claim 32, formed into the package, wherein the first polymer film defines an interior side of the package.

34. The material of claim 32, formed into the package, wherein the package includes a reclosable opening feature.

35. The material of claim 32, formed into the package, wherein the package includes a reclosable opening feature comprising a cover hingedly joined to a frame.

36. The material of claim 32, formed into the package, wherein the package includes a reclosable opening feature comprising a flexible cover adhesively joined to an exterior surface of the package.
